(19) United States
(12) Patent Application Publication
(10) Pub. No.: US 2003/0137611 A1
(43) Pub. Date: Jul. 24, 2003

(54) Optical Assembly

(76) Inventors: Fan-Chieh Chang, Hsinchu City (TW); Kuo-Wen Chen, Hsinchu City (TW); Chen-Wen Yang, Hsinchu City (TW)

(21) Appl. No.: 10/248,403

(22) Filed: Jan. 16, 2003

(30) Foreign Application Priority Data
Jan. 18, 2002 (TW) 091200737

(51) Int. Cl. H04N 5/74

(52) U.S. Cl. 348/787; 348/789

(57) ABSTRACT

### Abstract of Disclosure

The present invention is disclosed an optical assembly comprises an optical engine in a carrier, which is fixed a lower frame on the one side of the carrier. The lower frame has an inlet approach to one side of the optical engine that enable the projection lens of the optical engine to extend the lower frame. A first mirror is fixed on the other side of the lower frame, in front of the projection lens. Exit of the lower frame is on the optical path of the first mirror and is disposed on an inlet of the upper frame. A second mirror is fixed on rear of the upper frame on the optical path along with the optical reflection path of the first mirror. The optical reflection path of the second mirror faces the exit of the upper frame, which is provided a screen.

### Background of Invention

1.Field of the Invention

The present invention relates to a rear projection display, and more particularly relates to an optical assembly of optical system.

2.Description of the Prior Art

The importanceof visualization of information had been recognized widely with rapid development of optical technology, meanwhile, importance and demand of rear projection television, which is a part of display device, had increased rapidly. Hence, rear projection industry"s focus of research and development is to raise ability of products to compete by maintaining brightness and clear quality of image regarding productivity and cost, meanwhile still is easy to assemble and provide repair service.

Please refer to Figure 1 for the overall optical system structure of a prior-art rear projection television. A screen 14 in the front, a base 15 at the bottom, and a rear cover 16 at the backside constitute the interior of the rear projection television; wherein the interior of the rear projection television has a carrier 11 on the base 15, and the carrier 11 has an optical engine 10 on it. A first mirror 122 is fixed in the front of the optical engine 10, and furthermore a second mirror 131 is disposed on the inner side of the rear cover 16 at the back of the screen 14. The operation of the optical system of the rear projection television is by means of generating a beam with video information from the optical engine 10 on the carrier 11 and projecting the beam onto the first mirror 122. The beam is then reflected onto the second mirror 131 from the first mirror 122, and finally onto the screen 14, which constitutes the optical system projection architecture.

Maintaining each component in corresponding position and projection angle precisely is essential to prevent images from distortion and aberration. There are plenty of disadvantages of conventional optical assembly of projection television to be improved for. Since the optical engine 10, the first mirror 122, the second mirror 131 and the screen 14 are fixed on different supporting component, when using different appearance design, all optical system components must be adjusted, such adjustment takes man work and time meanwhile increases manufacturing cost; On the other hand, optical system must be moved whole when needs to be repaired, it and the above-mentioned adjustment all cause difficulty for repair.

### Summary of Invention

An object of the present invention is to provide an optical assembly that can suitable for various rear projection televisions with different appearance design to decrease cost and raise the ability of products to compete.

Another object of the present invention is to provide an optical assembly that is easily and movable to raise the efficiency of repairing and assembling.

These and other objects of the present invention are achieved by an assembly comprising an optical assembly is disclosed having an optical engine in a carrier, which is fixed a lower frame on the one side of the carrier. The lower frame has an inlet approach to one side of the optical engine that enable the projection lens of the optical engine to extend the lower frame. A first mirror is fixed on the other side of the lower frame, in front of the projection lens. Exit of the lower frame is on the optical path of the first mirror and is disposed on an inlet of the upper frame. A second mirror is fixed on rear of the upper frame on the optical path along with the optical reflection path of the first mirror. The optical reflection path of the second mirror faces the exit of the upper frame, which is provided a screen.

These and other objectives of the claimed invention will no doubt become obvious to those of ordinary skill in the art after reading the following detailed description of the preferred embodiment that is illustrated in the various figures and drawings.

### Brief Description of Drawings

FIG. 1 is a schematic view of an optical assembly according to the prior art;

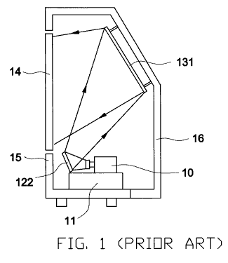

FIG. 2 is aperspective view of an optical assembly according to the present invention;

FIG. 3 is a cross-sectional view of an optical assembly according to the present invention;

FIG. 4is a perspective view of second embodiment of optical assembly according to the present invention;

FIG. 5 is an assembling schematic view of an optical assembly according to the present invention.

### Detailed Description

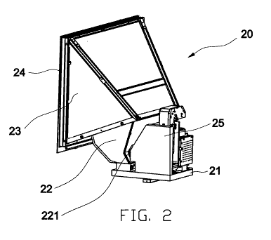

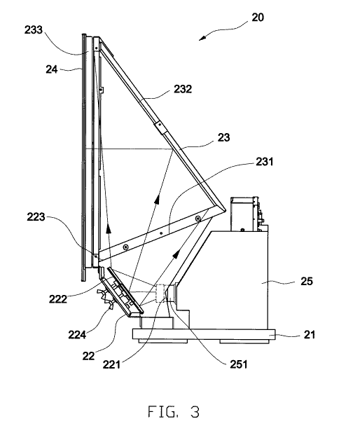

A preferred embodiment of the present invention will be explained with reference to the accompanying drawings. Please refer to FIG. 2 for the perspective view of the optical assembly according to a preferred embodiment of the present invention, which comprises an optical engine 25 in a carrier 21, which is fixed a lower frame 22 on the one side of the carrier 21. The lower frame 22 extend upward to form an upper frame 23, which is provided a screen 24 on the front of the upper frame 23 to constitute an optical assembly.Please refer to FIG. 3, the lower frame 22 has an inlet 221 approach to on side of the optical engine 25 that enable the projection lens 251 of the optical engine 25 to extend with an appropriate distance into the lower frame 22. A first mirror 222, to be used to reflect the light beam from the projection lens 251, is fixed inclinedly on the other side of the inlet 221 of the lower frame 22, in front of the projection lens 251. A plurality of adjusting components (such as screws) are disposed protuberantly in rear of the first mirror 222, i.e. the opposite side of the lower frame 22. Such adjusting components extend into a side of the lower frame 22 to support the first mirror 222, enable to adjust incline angle of the first mirror 222 to make optical adjustment. A exit 223 of the lower frame 22 faces the optical path of the first mirror 222 for reflecting light of the first mirror 222 to go through the exit 223. An inlet 231 of the upper frame 23 connect with the exit 231. A second mirror 232 is fixed on inner rear side of the upper frame 23 on the optical path along with the optical reflection path of the first mirror 222. The reflected light beam of the second mirror 232 from the first mirror 222 go through the exit 233 of the upper frame 23, and the exit 233 sets in front of the upper frame 23. A screen 24 is provided on the exit 233 to cover the exit 233.

Since the optical assembly 20 of the present invention containing components such as the optical engine 25 and the lower frame 22 are fixed on the carrier 21, the relative position of such components is fixed with the carrier 21. For the upper frame 23 is fixed on the lower frame 22, relative positions of the first mirror 222, the second mirror 232 and the screen 24 in the upper frame 23 and lower frame 22 interior are fixed basically. By merely maintaining the structure of the optical assembly 20 of the present invention, we can make relative positions and projection angle of the optical engine 25, the first mirror 222, the second mirror 232 and the screen 24 fixed, and make light beam which contain information from the optical engine 25 project into the lower frame 22 through the projection lens 251, then reflected to the first mirror 222, then enter into the inlet 231 of the upper frame 23 with being reflected by the first mirror 222 through the exit 223 of the lower frame 22 to make information being displayed on the screen 24 of the exit 233 through the second mirror 232, meanwhile we can ensure the optical precision and quality of the product.

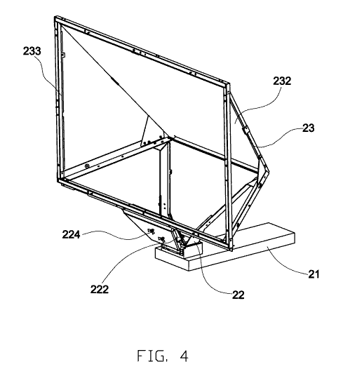

Similarly, the upper frame 23and the lower frame 22 of the optical assembly 20 of the present invention may be integrated as a whole one. Besides the aforementioned embodiment of plate type frame, please refer to FIG. 4, the present invention can fix the first mirror 222, the second mirror 232 and the screen 24 on the framework type frame to ensure the relative position of respective optical components. Moreover, the adjusting component224 of the first mirror 222 may be provided on the rear of the second mirror 232 to adjust the incline angle.

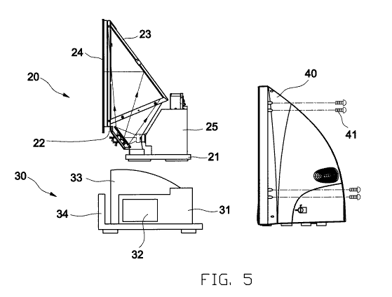

Please refer to FIG. 5, the present invention maintains fixed relative position and angle of respective optical components to constitute an independent optical assembly by the carrier 21, the lower frame 22 and the upper frame 23, therefore, the present invention is suitable for projection televisions in different design style of outlooks from various manufacturers. Upon assembling, just to fix the optical assembly containing the optical engine 25, the lower frame 22, the upper frame 23, the first mirror 222, the second mirror 232 and the screen 24 on the base 30 and the case 40, the base 30 includes the motherboard 31, the power supply 32,the speaker 33 and the panel 34, then the whole procedure is finished, without adjusting respective optical components of the optical assembly 20. When dissembling for repair, only to dissemble the whole optical assembly 20, won"t influence the relative optical precision of respective optical components, meanwhile, working efficiency is increased from preventing dissembling respective optical components and adjusting the relative position and angle when assembling.

Based on all the abovementioned, the present invention has following advantages in comparison with projection televisions of prior art:

1.The present invention maintains fixed relative position and angle of respective optical components to constitute an independent optical assembly by the carrier, the upper frame and the lower frame, is suitable for rear projection televisions in different design style of outlooks from various manufacturers.

2.The present invention provides a design of independent optical assembly. Upon dissembling, the whole optical assembly can be fixed on or moved from the base of rear projection television, assembling and repairing time can be decreased through decreasing adjustment of the relative position and angle of respective optical components can be decreased, hence working efficiency is increased, and reduce the cost.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures. In addition, the optical assembly of the present invention herein enhances the performance of the conventional method and further complies with the patent application requirements and is submitted to the Patent and Trademark Office for review and granting of the commensurate patent rights.

Claims

1. What claimed is:
1.An optical assembly, comprising:
a carrier has a upper surface;
an optical engine fixed on the upper surface, enable to project the light beam;
a lower frame fixed on the upper surface, is provided an inlet on the one side to receive the light beam; and provided a first mirror on the opposite side on the optical path to reflect the light beam to an exit;
a upper frame, is provided an inlet to connect the exit of the lower frame, and provided a second mirror in the rear on the optical path to reflect the light beam to an exit; and
a screen for covering the exit of the upper frame.

2.The optical assembly of claim 1,wherein the optical engine further comprising a projection lens to project the light beam.

3.The optical assembly of claim 2, wherein the projection lens extend to the inlet of the lower frame.

4.The optical assembly of claim 1, wherein the first mirror has an adjusting element for adjusting the angle.

5. 5 . The optical assembly of claim 1, wherein the second mirror has an adjusting element for adjusting the angle.

6. The optical assembly of claim 4, wherein the adjusting element passes through the frame side and protrude to the lower frame for adjusting the angle.

7. The optical assembly of claim 5, wherein the adjusting element passes through the frame side and protrude to the upper frame for adjusting the angle.

8. The optical assembly of claim 1, wherein the frame is plate type.

9. The optical assembly of claim 1, wherein the frame is framework type.

10. The optical assembly of claim 1, wherein the frame is a framework cover plate.
